(19) United States
(12) Patent Application Publication
(10) Pub. No.: US 2024/0122203 A1
(43) Pub. Date: Apr. 18, 2024

(54) REDUCED SUGAR MILK CHOCOLATE CONFECTIONERY PRODUCTS AND METHOD FOR MAKING THE SAME

(71) Applicant: THE HERSHEY COMPANY, Hershey, PA (US)

(72) Inventors: James St. John, Hershey, PA (US); Rebecca Thomas, Enola, PA (US); Xiaoying Wang, Hummelstown, PA (US)

(73) Assignee: THE HERSHEY COMPANY, Hershey, PA (US)

(21) Appl. No.: 18/534,808

(22) Filed: Dec. 11, 2023

Related U.S. Application Data
(62) Division of application No. 17/931,609, filed on Sep. 13, 2022.
(60) Provisional application No. 63/243,990, filed on Sep. 14, 2021.

(51) Int. Cl. A23G 1/40; A23G 1/36

(52) U.S. Cl. CPC A23G 1/40; A23G 1/36; A23V 2002/00

(57) ABSTRACT

The present disclosure relates to reduced sugar content milk chocolate confection and confectionery products comprising at least one rare sugar, such as allulose, methods of making the same wherein the confections and confectionery products have desirable rheological properties and organoleptic properties and stable viscosity over time. The present disclosure also relates to preventing thickening of reduced sugar content milk chocolate confections comprising at least one rare sugar, such as allulose, during manufacturing, and maintaining stable viscosity over time.

This application is a Non-Provisional Patent Application which claims benefit to U.S. Provisional Patent Application No. 63/243,990 filed Sep. 14, 2021, the entire contents of which are incorporated herein by reference.

### TECHNICAL FIELD

The present disclosure generally relates to reduced sugar content milk chocolate confections and confectionery products and methods of making the same.

The present disclosure also relates to a method for preventing thickening of reduced sugar content milk chocolate confections and confectionery products comprising at least one rare sugar, such as allulose, during manufacturing.

### BACKGROUND

Healthy eating trends have been driving innovation in the sugar-free/reduced sugar category as consumers seek healthier snacking options. Milk chocolate is the most popular chocolate or chocolate candy consumed in the United States. Milk chocolate confections having a reduced sugar content would therefore have widespread appeal. For milk chocolate, sugar reduction is commonly achieved using sugar alcohols which can sometimes be associated with unwanted laxative effects. Additionally, milk chocolates with sugar alcohols do not meet the “Standard of Identity” (Sol) hurdles in most countries. That is, milk chocolates containing sugar alcohols cannot be labeled as “Milk Chocolate” since sugar alcohols are not allowed in “Standard of Identity” chocolates. As a result, there is a desire to find a non-polyol sugar substitute for milk chocolate confectionery products having a reduced sugar content.

### SUMMARY

The present disclosure provides milk chocolate confections and milk chocolate confectionery products having a reduced sugar content. The milk chocolate confections, and confectionery products of the present disclosure comprise a fat; a sweetener comprising at least one rare sugar (including combinations of rare sugars), or a combination of at least one rare sugar and at least one standard carbohydrate sugar, wherein the at least one rare sugar is selected from the group consisting of allulose, tagatose, allose, sorbose, apiose, ribose, L-rhamnose, L-fructose, D-mannose, trehalose, and kojibiose; a milk ingredient; a cacao ingredient; an emulsifier/surfactant; and an optional bulk filler and/or flavor. The milk chocolate confectionery product has a stable plastic viscosity at 40° C. using the NCA/CMA Casson regression model of 500 to 10,000 cp, and a stable yield value at 40° C. using the NCA/CMA Casson regression model of 1-150 dynes/cm². The milk chocolate confectionery products can further have an apparent viscosity at 40° C. and 20 rpm (as measured by Brookfield viscometer) of 1,000 to 15,000 cp.

A method for making a milk chocolate confectionery product having a reduced sugar content in accordance with the disclosure includes mixing fat and a sweetener comprising at least one rare sugar (including combinations of rare sugars), or a combination of at least one rare sugar and at least one standard carbohydrate sugar, wherein the at least one rare sugar is selected from the group consisting of allulose, tagatose, allose, sorbose, apiose, ribose, L-rhamnose, L-fructose, and D-mannose to obtain a fat/sweetener mixture; refining the fat/sweetener mixture to obtain a particle size of <45 μm; adding water and a surfactant to the fat/sweetener mixture and drying. Separately unsweetened chocolate, milk ingredients for milk chocolate confections, and chocolate making ingredients are mixed to obtain a chocolate mixture and refining the chocolate mixture to obtain a particle size of <45 μm. The refined fat/sweetener mixture and the refined chocolate mixture are combined. The milk chocolate confectionery product has a stable plastic viscosity at 40° C. using the NCA/CMA Casson regression model of 500 to 10,000 cp, and a stable yield value at 40° C. using the NCA/CMA Casson regression model of 1-150 dynes/cm². The milk chocolate confectionery products can further have an apparent viscosity at 40° C. and 20 rpm (as measured by Brookfield viscometer) of 1,000 to 15,000 cp.

Other methods of producing a stable milk chocolate confection with rare sugars include increasing the fat level of the milk chocolate above 30% (by weight), overdosing the milk chocolate with emulsifiers/surfactants, and driving the total moisture of the milk chocolate below 1.5% (by weight).

The disclosure also provides a method of preventing or inhibiting thickening of milk chocolate which comprises at least one rare sugar. The method comprises reducing total surface area of particles of the at least one rare sugar, adding fat in an amount of about 30% by weight or more, and/or adjusting total moisture of the milk chocolate to below 1.5%, wherein the milk chocolate has a stable plastic viscosity at 40° C. using the NCA/CMA Casson regression model of 500 to 10,000 cp, and a stable yield value at 40° C. using the NCA/CMA Casson regression model of 1-150 dynes/cm². The milk chocolate can further have an apparent viscosity at 40° C. and 20 rpm (as measured by Brookfield viscometer) of 1,000 to 15,000 cp. In some examples the at least one rare sugar is in combination with other rare sugars or in combination with at least one standard carbohydrate sugar. In some examples, the at least one rare sugar is selected from the group consisting of allulose, tagatose, allose, sorbose, apiose, ribose, L-rhamnose, L-fructose, D-mannose, trehalose, and kojibiose.

### DRAWINGS

The various advantages of the embodiments will become apparent to one skilled in the art by reading the following specification and appended claims, and by referencing the following drawings in which:

FIGS. 1A and 1B illustrate thickened milk chocolate containing allulose.

FIG. 2 is an illustration of a process for making reduced sugar content milk chocolate confectionery products in accordance with the present disclosure.

FIG. 3 is an illustration of a process for making reduced sugar content milk chocolate confectionery products in accordance with the present disclosure.

FIG. 4 is a SEM micrograph showing a field of crystals in pre-processed refined allulose and cocoa butter.

FIG. 5 is a SEM micrograph showing a field of crystals in ground allulose and cocoa butter after processing with water and lecithin.

FIG. 6 is a graph illustrating a comparison between the initial apparent viscosity of chocolate confection products of the present disclosure and the apparent viscosity after 4 weeks of storage at 50° C.

FIG. 7 is a graph illustrating a comparison between the initial plastic viscosity of chocolate confection products of the present disclosure and the plastic viscosity after 4 weeks of storage at 50° C.

FIG. 8 is a graph illustrating a comparison between the initial yield value of chocolate confection products of the present disclosure and the yield value after 4 weeks of storage at 50° C.

### DESCRIPTION

The present disclosure provides milk chocolate confections and milk chocolate confectionery products having a reduced sugar content and methods for making the same. Rare sugars are a sweetening ingredient that enable lower sugar content levels on nutrition labels while still providing the taste and texture attributes desired by consumers. To be successful, milk chocolate with at least one rare sugar (including combinations of rare sugars) should possess rheological properties i.e., the flow properties, similar to typical milk chocolates to work within typical chocolate processing systems. Milk chocolate with at least one rare sugar should also meet plastic viscosity and yield values at 40° C., which range from 500-10,000 cp and 1-150 dynes/cm², respectively, for typical milk chocolates using the NCA/CMA Casson regression model. For purposes of this disclosure, “milk chocolate confection” or “milk chocolate confections” and “milk chocolate confectionery product” or “milk chocolate confectionery products” are used interchangeably.

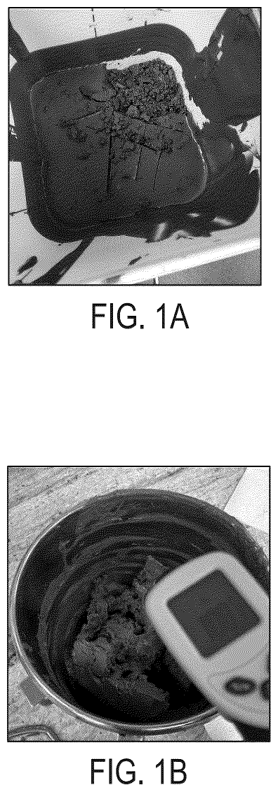

The present inventors have found that milk chocolate sweetened with at least one rare sugar, such as allulose, is significantly different in viscosity than typical milk chocolate after being held at moderate temperatures (100° F. (38° C.) to 120° F. (49° C.)) for extended periods of time. For example, milk chocolate sweetened with at least one rare sugar, such as, allulose, turns into a thick, dry mass with considerable oil separation over a timeframe of only a few days and it has been observed that when re-homogenized, the milk chocolate maintains a 7% to over 200% higher viscosity over a period of 7 days than was observed immediately after the milk chocolate was made. If the rheological properties (i.e., apparent and plastic viscosities and yield value) increase beyond the range of a typical chocolate or such that the measured properties increase by 200% or more throughout the first two weeks of storage, this could lead to processing difficulties or render the chocolate unusable. See FIGS. 1A and 1B which show milk chocolate sweetened solely with allulose.

To address this problem, the present disclosure provides methods for preventing or inhibiting thickening of milk chocolate which comprises at least one rare sugar. The methods include reducing the total surface area of particles of the sweetener comprising at least one rare sugar (including combinations of rare sugars), or a combination of at least one rare sugar and at least one standard carbohydrate sugar, adding fat in an amount of about 30% by weight or more, overdosing the milk chocolate with surfactants, and adjusting total moisture of the milk chocolate to below 1.5%. A milk chocolate confection or confectionery product with at least one rare sugar of the present disclosure will have a stable plastic viscosity and stable yield value at 40° C. of 500-10,000 cp or 600-10,000 cp, or 1,000-10,000 cp and 1-150 dynes/cm², respectively, using the NCA/CMA Casson regression model when prepared by the aforementioned methods. The milk chocolate confectionery products of the present disclosure may also have an apparent viscosity at 40° C. and 20 rpm (as measured by Brookfield viscometer) of 1,000 to 15,000 cp.

The present disclosure provides a milk chocolate confectionery which contains a fat, a sweetener comprising at least one rare sugar, a combination of rare sugars, or a combination of at least one rare sugar and at least one standard carbohydrate sugar, a nonfat milk ingredient, a cacao ingredient, an edible emulsifier/surfactant, and an optional bulk filler and/or flavor, wherein the chocolate has a stable plastic viscosity and yield value at 40° C. of 500-10,000 cp, or 600-10,000 cp, or 1,000-10,000 cp, and 1-150 dynes/cm², respectively, using the NCA/CMA Casson regression model.

Viscosity is a measurement of a fluid's resistance to flow. It is a quantity expressing the magnitude of friction between particles which are moving at different velocities. Viscosity directly affects chocolate utility in certain applications. In order to achieve certain quality parameters, chocolate or confectionery coating products must have specific flow properties. Viscosity is measured by a Brookfield viscometer in accordance with ICA Method 46. From the data, one can calculate plastic viscosity, the chocolate's resistance to flow, and yield value, the stress necessary to induce flow, using the NCA/CMA Casson regression model. For purposes of this disclosure, viscosity refers to “plastic viscosity” and “rheology” and “rheological properties” refer to overall flow behavior described by any of apparent or plastic viscosity or yield value (used interchangeably with “yield”).

Apparent viscosity values describe singular data points at particular shear rates and are widely used for materials such as chocolate whose flow behavior is dependent upon shear conditions. In the confectionery industry, this value is defined as the viscosity at 20 rpm measured at a standardized temperature (40° C.) and is used as a single data point to compare relative flow behavior amongst chocolates. The milk chocolate confectionery products of the present disclosure can have an apparent viscosity at 40° C. and 20 rpm (as measured by Brookfield viscometer) in the range of 1,000 to 15,000 cp, or in the range of 3,000 to 12,000 cp or 4,000 to 10,000 cp. The milk chocolate confectionery products of the present disclosure additionally have a plastic viscosity at 40° C. (as calculated by the NCA/CMA Casson regression) in the range of 500-10,000 cp, or 600-10,000, or 1,000 to 10,000 cp. Additionally, the plastic viscosity and yield value of the milk chocolate confectionery products of the present disclosure is stable at temperatures from about 10° F. (38° C.) to about 120° F. (49° C.) for at least a month.

Chocolate viscosity is typically measured using a Brookfield viscometer with concentric cylinder geometry, most commonly using an SC4-27 spindle. The instrument will generally have some method of temperature control, such as a water jacketed small sample adapter, to set the temperature to 40° C. during testing. The viscometer is traditionally programmed to pre-shear the chocolate at a low shear rate for a defined time and then gradually increase the rate of shear to a maximum, hold briefly at the maximum, and then gradually decrease to the initial low shear rate. Typical methods will utilize a pre-shear rate of 5 1/s for about 5-8 minutes, ramp from 2 to 50 1/s, hold at 50 1/s for one minute, then ramp back from 50 to 2 1/s. While the testing temperature of 40° C. is relatively constant throughout the industry, the remaining test parameters (i.e., shear rates and hold times) can fluctuate slightly depending on the laboratory, instrument, and/or individual chocolate samples.

From the data, one can obtain rheological values such as apparent viscosity, plastic viscosity, and yield value. Apparent viscosity in chocolate is defined as the 20-rpm value measured on the Brookfield viscometer and is typically reported in centi-Poise (cp). Although the SI unit for shear rate is reciprocal seconds (1/s), some instruments such as the Brookfield are programmed in terms of spindle rotations per minute (rpm). It is possible to convert between the two units using the geometry and dimensions of the spindle and cup. If there is both an up and down ramp of shear rate, the 20-rpm value on the down ramp will typically be reported as the apparent viscosity. Additionally, data is typically fitted to the National Confectioners Association/Chocolate Manufacturers Association (NCA/CMA) Casson model to calculate plastic viscosity and yield value. Plastic viscosity is defined as the resistance to flow and is an indication of how readily a chocolate will continue flowing once in motion, reported in centi-Poise. The yield value is the stress (force per area) needed to initiate flow and is typically reported in dynes/cm². Both plastic viscosity and yield are of importance to the confectioner as they are indications of a chocolate's suitability to various processes such as enrobing and molding. The intended use of the chocolate impacts the optimum plastic viscosity and yield value desired. As such, if a chocolate's rheological properties substantially increase from its optimum values (based on its intended use) over storage, it may become unusable.

Stability in terms of the milk chocolate confectionery products of the present disclosure being stable refers to possessing and/or maintaining acceptable rheological properties, i.e., flowability at temperatures from about 100° F. (38° C.) to about 120° F. (49° C.) for at least about a month.

The milk chocolate confectionery products of the present disclosure include a cacao ingredient. Cacao refers to cocoa which is derived from the fruit of the Theobroma cacao tree and may be referred to as cocoa beans, cocoa mass, cocoa solids, cocoa butter or cocoa liquor, and combinations thereof.

The milk chocolate confectionery products of the present disclosure include a milk ingredient. Milk ingredients include, but are not limited to skim milk, whey, cream, milk fat, and milk proteins.

The milk chocolate confectionery products of the present disclosure include a sweetener comprising at least one rare sugar (including combinations of rare sugars), or a combination of at least one rare sugar and at least one standard carbohydrate sugar. The at least one rare sugar is selected from the group consisting of allulose, tagatose, allose, sorbose, apiose, ribose, L-rhamnose, L-fructose, D-mannose, trehalose, and kojibiose and combinations thereof. For purposes of this disclosure, a standard carbohydrate sugar is a common carbohydrate sugar with varying degrees of sweetness intensity useful in the present disclosure, which can be any of those typically used in the art and include, but are not limited to, sucrose, (e.g., from cane or beet), dextrose, fructose, lactose, maltose, glucose syrup solids, corn syrup solids, invert sugar, hydrolyzed lactose, honey, maple sugar, brown sugar, molasses, and the like, and combinations thereof. The at least one standard carbohydrate sweetener, preferably sucrose, will be present in the chocolate as crystals or particles.

The particle size of the ingredients, especially the sweetener, and more specifically the particle size of the at least one rare sugar, such as allulose, can influence the viscosity of the chocolate. Particle sizes can be measured by various techniques known to those skilled in the art. These techniques include the MALVERN® and SYMPATEC® light scattering techniques, measurement using a micrometer and measurement using a microscope and the like. Unless otherwise specified herein, when referring to the particle size distribution of the sweetener comprising at least one rare sugar, a combination of rare sugars, or a combination of at least one rare sugar and at least one standard carbohydrate sugar, and milk chocolate confections, the measurements were taken using the SYMPATEC® laser light scattering technique. Furthermore, unless otherwise specified herein, when referring to the particle size of the finished chocolate, the measurements were taken using a micrometer. In some examples, the particle size of the sweetener comprising at least one rare sugar, a combination of rare sugars, or a combination of at least one rare sugar and at least one standard carbohydrate sugar, a nonfat milk solid, and the nonfat cocoa solids are within a certain specified range in order to maintain specified rheological properties.

The present inventors have found that during processing and/or manufacturing of milk chocolate confections containing at least one rare sugar, such as allulose, the chocolate thickens into a hard dry mass. Traditional milk chocolate processing includes mixing unsweetened chocolate, sugars (typically sucrose and lactose), milk powder, fats (e.g., cocoa butter, milk fat or other suitable fats) and flavors; size reducing the mixture (roll refining, media milling or other appropriate size reduction techniques); and conching the mixture with added additional fats and surfactants. This process results in a stable suspension of nonfat particles (cacao, milk, and sugars). However, milk chocolates containing at least one rare sugar, such as allulose, tend not to be stable and thicken to a point where the suspension is no longer flowable. This is a problem in the production of confections. While not wishing to be bound by this theory, such thickening may be due to the formation of networks that form between rare sugar particles (for example, allulose:allulose particle interactions) or rare sugar and fats and/or milk ingredients (for example, allulose:fat/milk interactions). The present inventors have found that by reducing the surface area of the at least one rare sugar, such as allulose, used in combination with milk chocolate as in the present disclosure, employing a high fat system, overdosing emulsifiers/surfactants, and/or reducing moisture of the milk chocolate confection containing at least one rare sugar, such as allulose, the problem of thickening and development of other undesirable rheological properties can be alleviated or substantially reduced, and the plastic viscosity and yield value of milk chocolate containing at least one rare sugar such as allulose, can be stabilized.

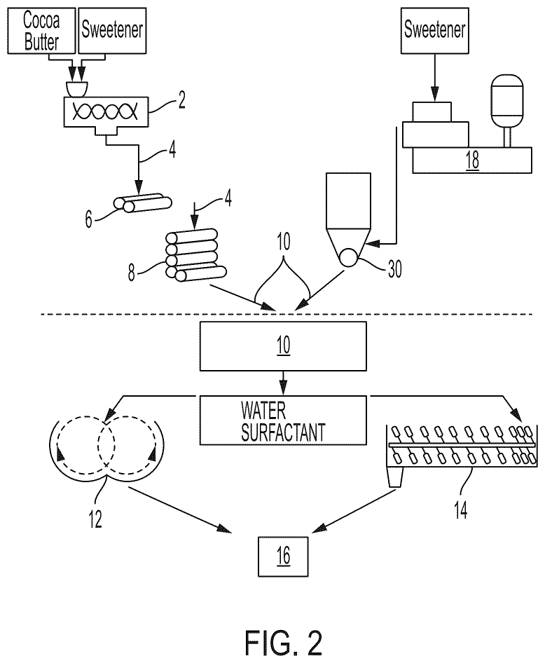

Lower surface area of the at least one rare sugar particles, such as allulose, can be obtained as described in U.S. Pat. No. 5,464,649, which is incorporated herein by reference, or through other methods including alternative size reduction techniques, such as a melanger process, ball mill, air classifying and other known methods. Namely, with respect to the process described in U.S. Pat. No. 5,464,649, the fat and sweetener comprising at least one rare sugar, a combination of rare sugars, or a combination of at least one rare sugar and at least one standard carbohydrate sugar are mixed and then passed through a particle size reduction process, typically roll refining or milling a sweetener containing at least one rare sugar as shown in FIG. 2. In the roll refining process, the fat (e.g., cocoa butter) and sweetener are mixed in batch mixer 2 to form a mixture 4 which is then passed through the nip of at least one pair of roll refiners (6, 8) to produce a mixture 10 having particles smaller than about 50 microns. Water, in the amount of 1 to 10% by weight of the sweetener comprising at least one rare sugar, a combination of rare sugars, or a combination of at least one rare sugar and at least one standard carbohydrate sugar, is added to the mixture 10 for the purpose of dissolving fines and rounding larger crystals.

Alternatively, the mixture 10 can be prepared by first refining the sweetener in a mill 18 and then blending the sweetener with the fat or combination thereof in a blender 30 in accordance with procedures known to one skilled in the art.

An emulsifier/surfactant is added to the mixture 10 before drying to prevent agglomeration. Accordingly, the addition of emulsifiers/surfactants, e.g., lecithin, preferably in amounts less than 1% by weight, in the presence of small amounts of water, preferably 1-5% by weight, along with agitation throughout the drying process will prevent agglomeration. For the drying step, both batch and continuous driers yield a flowable, non-agglomerated paste. For batch drying, typical chocolate conches 12 yield good results. Typical drying times are from about 60 to about 120 minutes at temperatures of about 120° F. to about 160° F. (49° C. to about 71° C.). For continuous drying, paddle driers 14 have proven successful. Typical drying times for paddle dryers are approximately 40 to about 120 minutes at temperatures of about 120° F. to about 180° F. (49° C. to about 71° C.) for acceptable results. Both drying processes result in a sweetener/fat paste 16 which is agglomerate free, flowable and has low viscosity. Preferably, in accordance with the present disclosure, the drying produces a product having 10-24% of fat (w/w) in the sweetener/fat paste. The moisture content is preferably less than 0.2% wt. No secondary size reduction step is necessary. This paste is then added to the other ingredients which have been reduced to finished particle size specification. This final mixture is conched and standardized to the specified fat level.

The desired reduction of the surface area of the sweetener can be accomplished with other confectionery ingredients present during the water/surfactant addition. These ingredients include chocolate liquor, cocoa powder, and milkfat.

Another method of reducing the surface area of the particle size of the sweetener comprising at least one rare sugar, a combination of rare sugars, or a combination of at least one rare sugar and at least one standard carbohydrate sugar is by controlling the crystallization of a supersaturated solution of the at least one standard carbohydrate sugar while drying the standard carbohydrate syrup.

An additional method calls for the size reduction of sweetener comprising at least one rare sugar, a combination of rare sugars, or a combination of at least one rare sugar and at least one standard carbohydrate sugar by any number of accepted milling techniques. A Micropul ACM mill will reduce the particle size of the sweetener within the desired range with a reduction of ultrafines and total surface area as compared to typical roll refining. Once the sweetener size has been reduced, the total surface area can be further reduced by physically removing particles below a specified size. Air classification can successfully separate smaller particles by taking advantage of the weight difference between the lighter small particles and the heavier larger particles. Other methods, such as screening, are also possible in removing the ultrafines from the size-reduced sweetener.

Aside from preparing the particle size of the sweetener comprising at least one rare sugar, a combination of rare sugars, or a combination of at least one rare sugar and at least one standard carbohydrate sugar, another method of reducing surface area is to densify any or all of the ingredients. In particular, dried milk solids can be greatly densified. Typically, spray dried whole milk powder (WMP) and spray dried non-fat milk solids (NFMS) are used in chocolate. Low density, highly porous sponge-like particles are created by the spray drying process. The density of the powder can be increased to a particularly dense state by either altering the spray drying process or by further processing of the dried product.

In one example, the nonfat milk solids are pretreated to compact the structure and crystallize a substantial portion of the lactose present in the milk solids. The bulk density (packed) should preferably exceed 0.7 g/ml and the degree of lactose conversion from the amorphous to crystalline state preferably exceeds 30%, more preferably above 70%. Thus, nonfat dry milk powder can be prepared in a variety of ways.

By introducing a lactose crystallization step before spray drying, the density of the dried powder is greatly increased. By pre-crystallizing the lactose, it enters the spray drier in a dense alpha monohydrated crystalline state and does not “puff-up” in a porous amorphous state. With lactose making up over 50% of NFMS, the overall density of the NFMS is increased.

For normal spray dried powder, the density can be increased by rewetting the powder and drying under pressure. The NFMS is dispersed into water (15 to 30% added water by weight relative to the NFMS) and dried under pressure either in a melanger or through roll refiners. A secondary drying step may aid in bringing the final moisture to below 3%. During this process, the amorphous lactose is dissolved and dried in a crystalline state. The other solids are also pressurized and dried into a more collapsed, less porous state.

In a further method, the nonfat spray dried milk powder can also be compacted with sufficient heat and water in a twin screw extruder to collapse the protein structure and crystallize the amorphous lactose.

In some examples of the present disclosure, the size of the particles of the sweetener are substantially below 60 microns. In other examples, substantially all of the particles are below 50 microns in size. In additional examples, substantially all of the particles are below 45 microns in size. “Substantially all” refers to at least 80% of the particles. The total surface area of the sugars has been significantly reduced with the water treatment. Many sugar crystals below 6 microns (referred to as “fines”) in diameter were dissolved in the water. While drying, the dissolved sugar recrystallizes on the larger sugar crystals. This recrystallization rounds out the larger crystals without significantly increasing the total size of the crystals. This results in reducing the total surface area of the sugars by almost 50% and reducing the number of fines (as measured and calculated from SYMPATEC® data). To calculate the surface area, the inventors used the data generated in the SYMPATEC® analysis. Percentages of the total volume are reported between various diameters of particles. Assuming diameters of particles to be in the middle of the reported diameters, one can calculate a total surface area of a sample. While not wishing to be bound by any theory, the reduction of surface area significantly decreases the opportunity of allulose crystals from forming a network and therefore prevents the milk chocolate from thickening. In one or more examples of the disclosure, the particle size distribution of the at least one rare sugar particles≥6.0 μm is about 15% or less. In other examples, the particle size distribution of the at least one rare sugar particles≥6.0 μm is about 13% or less or about 11% or less (as measured by SYMPATEC®). The total surface area is also reduced by almost 50%.

As used herein, unless otherwise specified, all percentages are calculated on a weight basis of ingredient to chocolate. For example, if an ingredient is present in 10%, it is meant that there are 10 g of that ingredient in 100 g of chocolate.

The present inventors have also found that a high fat content contributes to stable rheological properties for milk chocolate confections containing at least one rare sugar, such as allulose. Thus, the milk chocolate confectionery products of the present disclosure contain a relatively high fat content of equal to or greater than about 30% by weight. In some examples, the milk chocolate confectionery products of the present disclosure can have a fat content of about 2 36% by weight, about ≥38% by weight or about ≥40% by weight. Fats, as used herein, refer to triglycerides, diglycerides and monoglycerides that can normally be used in chocolates. Fats include the naturally occurring fats and oils such as cocoa butter, pressed cocoa butter, expeller cocoa butter, solvent extracted cocoa butter, refined cocoa butter and the like and also cocoa butter substitutes, including but not limited to, palm oil, palm kernel oil, shea oil, sunflower oil, safflower oil, illipe oil, and the like.

Another characteristic of the milk chocolate confections of the present disclosure containing at least one rare sugar, such as allulose, for reduced sugar content having desirable rheological properties and maintaining stable plastic viscosity and yield value, is a low moisture content. In this regard, the milk chocolate confectionery products of the present disclosure may contain a trace of water. Milk chocolate containing at least one rare sugar, such as allulose, thickens during processing and manufacturing, and is unusable at greater than 1.5% moisture. In order to meet the flow requirements and prevent thickening of milk chocolate during processing, in the present disclosure, steps are taken to reduce the moisture level to below 1.5% by weight. More specifically, the total moisture content of the milk chocolate confectionery products is equal to or less than about 1.2% by weight. In some examples, the moisture content is equal to or less than about 1.0% by weight or equal to or less than about 0.8% by weight, or equal to or less than about 0.6% by weight.

The milk chocolate confectionery products of the present disclosure contain emulsifiers/surfactants. For purposes of this disclosure, the terms “emulsifier” and “surfactant” are used interchangeably and the term “emulsifier/surfactant” refers to “emulsifier” or “surfactant” or both “emulsifier and surfactant”. Examples of safe and suitable emulsifiers/surfactants can be any of those typically used in the art and include lecithin derived from vegetable sources such as soybean, safflower, corn, etc., fractionated lecithins enriched in either phosphatidyl choline or phosphatidyl ethanolamine or both, polyglycerol polyricinolete (PGPR), mono- and digylcerides, diacetyl tartaric acid esters of mono- and diglycerides (also referred to as DATEM), monosodium phosphate derivatives of mono- and diglycerides of edible fats or oils, sorbitan monostearate, polyoxyethylene sorbitan monostearate, hydroxylated lecithin, lactylated fatty acid esters of glycerol and propylene glycol, polyglycerol esters of fatty acids, propylene glycol mono- and diester of fats and fatty acids or any emulsifier/surfactant that may become approved for the USFDA-defined soft candy category. In addition, other emulsifiers/surfactants that can be used in the present disclosure, include polyglycerol polyricinoleate (PGPR), ammonium salts of phosphatidic acid including ammonium phosphatide (AMP), sucrose esters, oat extract, etc., and any emulsifier found to be suitable in chocolate or a similar fat/solid system or any blend provided the total amount of emulsifier does not exceed 1% by weight. Emulsifiers/surfactants preferred for use in the present disclosure are lecithin, fractionated lecithin, PGPR, AMP, diacetyl tartaric acid esters of mono- and diglycerides (DATEM), and combinations or mixtures of these emulsifiers/surfactants at a maximum level of 1% by weight of any one emulsifier/surfactant or any mixture of emulsifiers/surfactants. Once a chocolate is made, small doses of emulsifier/surfactants are added and mixed in well. Then the rheological measurements are taken. This procedure is continued until the plastic viscosity and yield value no longer decrease. The recommended level of emulsifier/surfactant is the level at which the plastic viscosity and yield value are minimized. The most common emulsifier/surfactant, soy lecithin will lower plastic viscosity and yield value to a point. For milk chocolate, chocolate makers have found approximately 0.3% to 0.4% by weight of lecithin is the optimum amount of lecithin to minimize plastic viscosity and yield value. Beyond its optimum use level, lecithin will cause an increase in yield value. Chocolate makers do not add additional lecithin beyond this optimum level due to possible issues in downstream processes that higher yield values will cause. The inventors discovered that higher levels than the traditional milk chocolate optimum levels for minimizing plastic viscosity and yield value will prevent allulose milk chocolate from thickening. For example, a small batch of allulose milk chocolate (AMC) was prepared in the lab. The lecithin and PGPR levels to minimize plastic viscosity and yield value were initially determined to be 0.3% by weight and 0.1% by weight, respectively, based on the flow properties of the chocolate at the end of conching. This AMC thickened over time. However, when the lecithin and PGPR levels were increased to 0.9% by weight and 0.3% by weight, respectively, the AMC did not thicken over time. In some examples, the emulsifier/surfactant employed in the milk chocolate confectionery products of the present disclosure comprises lecithin having a content of about 0.2% to about 0.9% by weight, about 0.3% to about 0.7% by weight, or about 0.4% to about 0.6% by weight. In some examples, the emulsifier/surfactant employed in the milk chocolate confectionery products of the present disclosure comprises PGPR having a content of about 0.1% to about 0.3% by weight. In yet some other examples, the emulsifier/surfactant employed in the milk chocolate confectionery products of the present disclosure comprises a combination of lecithin and PGPR having a content of lecithin of about 0.6% by weight, and a content of PGPR of about 0.2% by weight.

In other examples, the emulsifier/surfactant employed in the milk chocolate confectionery product of the present disclosure comprises AMP having a content of about 0.1% to about 0.7% by weight or 0.5% to 0.7% by weight. In additional examples, the emulsifier/surfactant employed in the milk chocolate confectionery products of the disclosure comprises a combination of lecithin and AMP.

The chocolates of the present disclosure may additionally contain optional ingredients. These optional ingredients include nonfat milk solids, nonfat cocoa solids, sugar substitutes, bulk fillers, also referred to as bulking agents (e.g., corn fiber, polydextrose, fructooligosaccharides, inulin, sugar alcohols, calcium carbonate, and the like.), natural and artificial flavors (e.g., vanillin, spices, coffee, ethyl vanillin, salt, brown nut-meats, natural vanilla, etc., as well as mixtures of these), antioxidants (e.g., preservatives such as TBHQ, tocopherols and the like), proteins, and the like.

In some examples, the chocolate contains substantially all particles having a size of less than 45 microns as measured by a micrometer for coatings and less than 40 microns for solid bars and novelty shapes.

The milk chocolate confectionery products of the present disclosure include for example, candy bars, baking chocolate, chocolate chips, ice cream bars, refrigerated desserts or other foods in which milk chocolate is an ingredient. In these foods, the milk chocolate has the rheological flow properties associated with typical milk chocolate confections containing normal levels of standard sugar content chocolate but with at least one rare sugar, such as allulose. The preparation of a milk chocolate confectionery product having a reduced sugar content using at least one rare sugar, such as allulose, was unexpectedly problematic due to thickening during processing and/or manufacturing and unstable viscosity. The present inventors found that such thickening and unstable viscosity is prevented by reducing the surface area of the sweetener containing at least one rare sugar, such as allulose, employing a high fat system, overdosing the chocolate with emulsifiers/surfactants, and/or reducing moisture levels to below 1.5 wt % to obtain a reduced sugar content milk chocolate confectionery product having rheological properties suitable for enrobing, molding, or extruding.

To obtain and maintain desirable rheological and organoleptic properties of milk chocolate confections and milk chocolate confectionery products of the present disclosure can be prepared by mixing a fat and a sweetener comprising a at least one rare sugar or a combination of at least one rare sugar and at least one standard carbohydrate sugar, wherein the at least one rare sugar is selected from the group consisting of allulose, tagatose, allose, sorbose, apiose, ribose, L-rhamnose, L-fructose, D-mannose, trehalose, and kojibiose. to obtain a fat/sweetener mixture; refining the fat/sweetener mixture to obtain a particle size of 45 μm; and adding water and an emulsifier/surfactant to the fat/sweetener mixture and drying; separately mixing unsweetened chocolate, milk ingredients for milk chocolate, and chocolate making ingredients to obtain a chocolate mixture and refining the chocolate mixture to obtain a particle size of 45 μm; and combining the refined fat/sweetener mixture and the refined chocolate mixture. The milk chocolate confection or milk chocolate confectionery product has an apparent viscosity at 40° C. and 20 rpm (as measured by Brookfield viscometer) of 1,000 to 15,000 cp and a plastic viscosity and yield value at 40° C. of 500-10,000, or 600-10,000, or 1,000-10,000 cp and 1-150 dynes/cm², respectively, using the NCA/CMA Casson regression model.

The surface area of the standard carbohydrate sweetener can be reduced by a water addition and recrystallization operation as described in U.S. Pat. No. 5,464,649, which is incorporated herein by reference and described herein above.

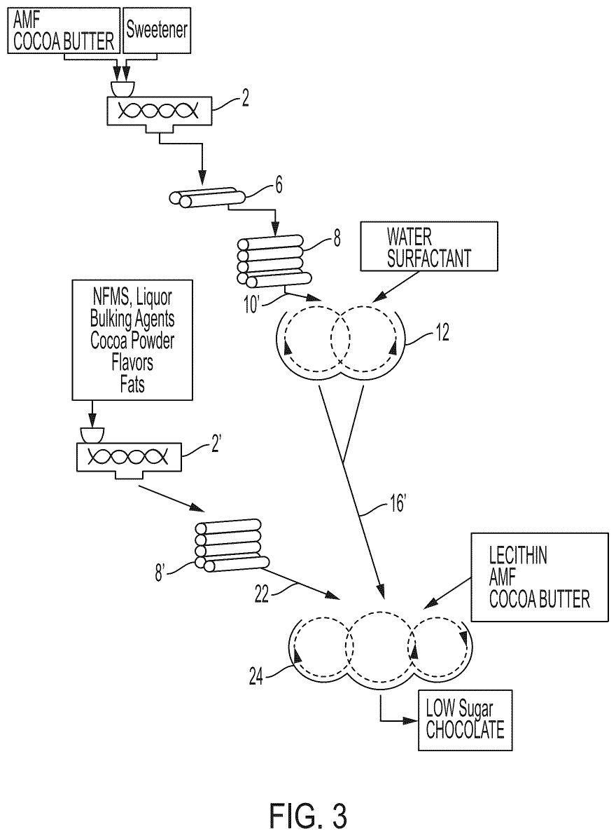

FIG. 3 generally illustrates a process for preparing a milk chocolate confectionery product in accordance with the present disclosure. Fat (e.g., cocoa butter) and sweetener comprising at least one rare sugar, such as allulose, are mixed in a batch mixer 2. The mixture is subsequently refined by being passed through the nips of a plurality of roll refiners (6, 8) to produce a mixture 10′ containing sweetener/fat particles (at least one rare sugar or combination of at least one rare sugar and at least one standard carbohydrate sweetener/fat particles), preferably smaller than about 60 microns. In this particular example of the process of the present disclosure, water and emulsifier/surfactant are added to the sweetener/fat mixture and subjected to the drying process e.g., in a conch 12 (or in a paddle dryer) to obtain a 25% fat by weight of a sweetener/fat paste 16′ with a moisture content of less than 1.5% wt.

Apart from the preparation of the sweetener/fat paste described above, the other milk chocolate-making ingredients may be prepared separately. Said additional ingredients include, but are but not limited to, nonfat milk solids, bulking agents, cocoa powder, flavors, and fats. With respect to FIG. 3, chocolate liquor, nonfat milk solids and anhydrous milk fat (AMF), cocoa butter, bulking agents, and flavors are mixed in a batch mixer 2′ and subsequently refined by being passed through the nips of a plurality of roll refiners (8′) to produce a mixture 22 having particles preferably smaller than about 50 microns.

The sweetener/fat paste 16′ can then be mixed with the mixture 22 in a conch 24 while heating to give the final desired consistency to the chocolate. Additional fat and emulsifiers, e.g., lecithin, anhydrous milk fat, and cocoa butter, are then added in the standardizing step, as shown in FIG. 3, to adjust the viscosity of the chocolate to final specifications and to produce a milk chocolate confection having reduced sugar content and plastic viscosity of about 500-10,000 cP and yield of about 1-150 dynes/cm² (as calculated by NCA/CMA Casson).

The chocolates of the present disclosure can be used in a solid bar in which the entire bar is made up of solely chocolate. The solid bar is preferably a geometrical shape, for example, a circle, a rectangle, or a square.

The chocolates of the present disclosure can additionally be used as a coating. As used herein, the term “coating” refers to a food which is covered or enveloped with a chocolate. Various foods which may be coated include fruits (e.g., cherries, strawberries, bananas, and the like), marshmallow, cake, cookies, toffee, peanut butter, caramel, nuts, raisins, nougat, baked goods, ice cream bars, candy bars, puddings, creams, and the like. Consequently, as used herein, a solid bar with inclusions is a type of coating.

Apart from being used in a solid bar and as a coating, the chocolates of the present disclosure can also be used in making novelty shapes as previously defined.

The milk chocolate confectionery product having a reduced sugar content due to the incorporation of at least one rare sugar in the sweetener and made according to the process of the present disclosure, has desirable flow properties and stabilized viscosity for at least 24 hours to a month. Because of the unique composition and method, the chocolate of the present disclosure meets flow requirements for both molding, and enrobing.

### EXAMPLES

Reduced sugar content milk chocolate confections of the present disclosure are further described in the context of the following examples, which are presented by way of illustration, but are not intended to limit the invention.

### Example 1: Reducing Surface Area Through a Water Addition Processing

Allulose milk chocolates were prepared by the process described in U.S. Pat. No. 5,464,649, which is incorporated herein by reference. The formula is shown in Table 1 below. Allulose and cocoa butter (2000 grams at 23% fat by weight) were mixed and ground on a Buhler 300 mm roll refiner to a particle size of 25 microns (measured by a handheld micrometer). Separately, 1500 grams of unsweetened chocolate, nonfat milk solids and vanillin (aka “others”) were mixed in the ratio in the formula below and ground on a Buhler 300 mm roll refiner to 20 microns.

TABLE 1
Allulose Milk Chocolate Formula (% by weight)

| | |
|---|---|
| Allulose | 45.07% |
| Cocoa Butter | 19.00% |
| Unsweetened Chocolate | 15.00% |
| AMF | 4.00% |
| Non-Fat Milk Solids | 16.50% |
| Lecithin | 0.30% |
| PGPR | 0.10% |
| Vanillin | 0.03% |
| Total | 100.00% |
| Percent Fat | 31.48% |

The allulose/cocoa butter (i.e., fat) mixture was split into two separate batches: Batch A and batch B. The two batches were put into 8 qt Globe mixers. The two batches had different treatments:
Batch A: Addition of 2% water by weight and 0.3% lecithin by weight.
Batch B: Addition of 0.3% lecithin.

The bowls were placed in 115° F. (46° C.) water baths, and the mixers were set to speed 1.

Once Batch A (the mixture with added water), was dry (after 3 hours of processing), the appropriate amount of the unsweetened chocolate/non-fat milk solids/vanillin ground mixture was added to Batch A. The mixture of Batch A was conched for 2 hours at 115° F. (46° C.). At that point, the balance of the fats and surfactants was added, and the batches were further mixed for 30 minutes. The samples were then stored in a hot box set for 115° F. (46° C.).

The mixture of Batch B was conched for 3 hours. Then the appropriate amount of the unsweetened chocolate/non-fat milk solids/vanillin ground mixture was added to Batch B. The mixture was conched for 2 hours at 115° F. (46° C.). At that point, the balance of the fats and surfactants was added to Batch B and the batches were further mixed for 30 minutes. The samples were then stored in a hot box set for 115° F. (46° C.).

Meanwhile a separate 2,000-gram milk chocolate sample with allulose as the rare sugar was prepared. The ingredients were mixed at a total fat content of 24% and were ground using a Buhler 300 mm roll refiner. The ground mixture was conched in an 8 qt Globe mixer at speed 1 for three hours at 115° F. (46° C.). After three hours, the balance of the fats and surfactants was added, and the batches were further mixed for 30 minutes. The sample was then stored at 115° F. (46° C.).

Results:

The particle size distributions of the refined allulose and cocoa butter (CB) batches before and after processing are shown in Table 2 below. The initial refined allulose/CB was slightly coarse with only 18% below 6.2 mm, as measured by a SYMPATEC® Laser Diffraction process, and 83% of the particles below 32 mm (this is normally assumed to match a handheld micrometer reading). The water addition sample was typical of the process described in U.S. Pat. No. 5,464,649. The 83% point did not increase significantly (32 to 34 mm) while the fines dropped from 18% to only 11% of the volume of allulose. In addition, the calculated surface area from the laser diffraction (SYMPATEC®) data showed a reduction in surface area from 1.50 cm²/gr to 0.86 cm²/gr or a 43% reduction in surface area. This includes the assumption that the crystals are spherical—which they are not. Therefore, this is an underestimation of the reduction in surface area. Since the crystals in the pre-treated sample are very angular and jagged, they will have greater surface area than reported as opposed to the post treated sample crystals that have been rounded off by the addition of recrystallization of the dissolved allulose.

TABLE 2

| | SYMPATEC ® PSD Data | | | | | Surface | |
|---|---|---|---|---|---|---|---|
| | <6.2 | <50 | <74 | 83% | 95% | Area | |
| Sample | mm | mm | mm | (mm) | (mm) | cm²/gr | Moisture |
| Refined | 18.0% | 96.1% | 97.9% | 32.1 | 48.0 | 1.50 | |
| Allulose/CB | | | | | | | |
| Allulose, CB, | 11.2% | 97.5% | 100.0% | 34.3 | 45.7 | 0.86 | 0.10% |
| H₂O, Lecithin | | | | | | | |

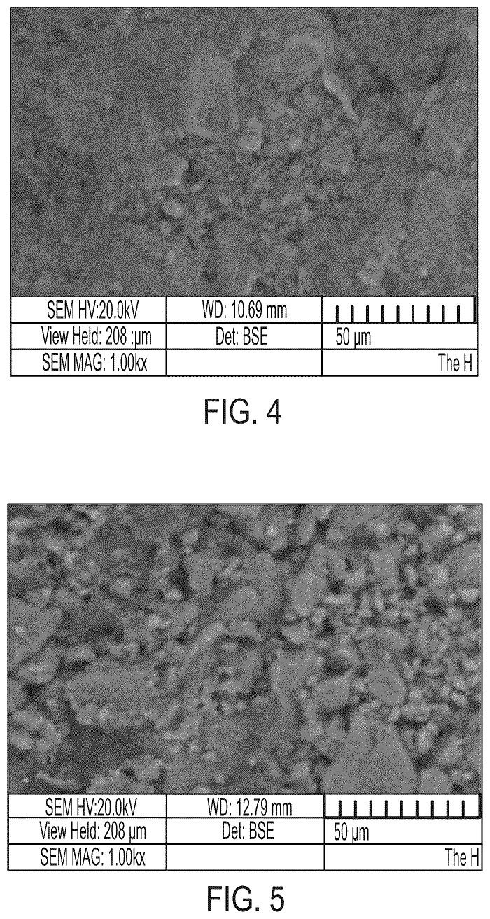

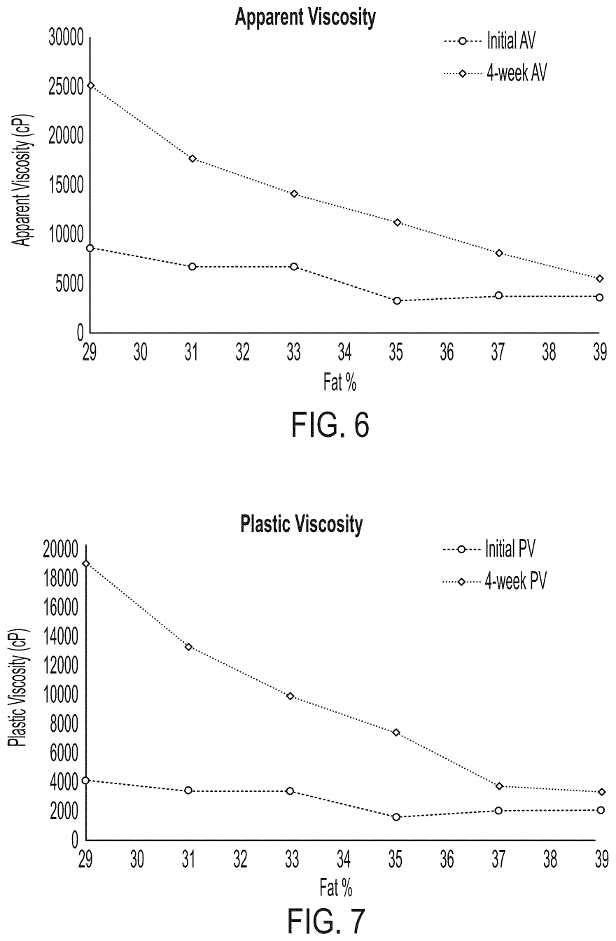

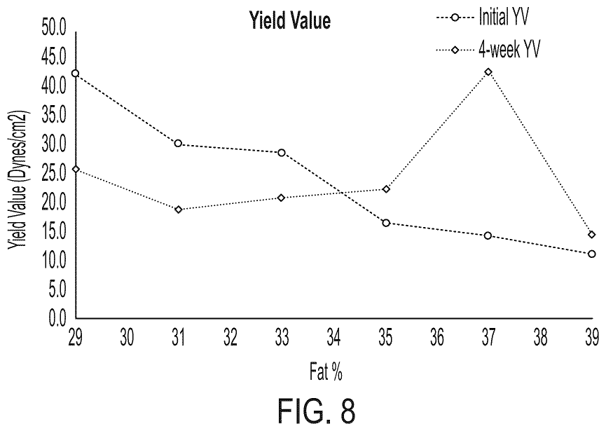

The SEM micrographs of the samples as shown in FIGS. 4 and 5 further sheds light on the impact of the additions and processing. The micrograph of the pre-processed refined allulose and cocoa butter (FIG. 4) shows a typical field of a few large crystals surrounded in a sea of fine crystals. The micrograph of the water addition sample (FIG. 5) shows a significant reduction in fines and the larger crystals are more rounded. Those rounded crystals have less surface area than a typical ground crystal.

Finished Milk Chocolate

As shown in Table 3 below, the first three variants were within the target on particle size. 19 to 22 mm is acceptable for a tablet chocolate. The results of the water addition processed allulose milk chocolate were as expected. The low yield value of the sample is typical of a water addition process. The yield value (YV) and plastic viscosity (PV) as calculated by NCA/CMA Casson regression of non-water added product were significantly higher. The conventionally processed sample had even higher rheology results.

TABLE 3

| Allulose | SYMPATEC ® PSD Data | | | | | Surface | | | Initial Casson | |
|---|---|---|---|---|---|---|---|---|---|---|
| Milk | <6.2 | <50 | <74 | 83% | 95% | Area | | AV at 20 | PV | YV |
| Chocolate | mm | mm | mm | (mm) | (mm) | cm²/gr | Moisture | rpm (cp) | (cp) | (dy/cm²) |
| Allulose MC | 36.6% | 100.0% | 100.0% | 19.6 | 27.1 | 66 | 0.77% | 4050 | 1751 | 23.7 |
| (water, | | | | | | | | | | |
| lecithin | | | | | | | | | | |
| processed) | | | | | | | | | | |
| Allulose MC | 33.4% | 100.0% | 100.0% | 21.5 | 31.0 | 116 | 0.84% | 15130 | 5956 | 99.5 |
| (lecithin | | | | | | | | | | |
| processed) | | | | | | | | | | |
| Conventionally | | | | | | | | | 3638 | 142.8 |
| Processed | | | | | | | | | | |
| Allulose MC | | | | | | | | | | |

Table 4 below shows the change in apparent viscosity, plastic viscosity, and yield value over time. The water addition sample did not show an increase in any value. The sample where allulose was ground separately from the other ingredients but was not treated with water had a significant increase (50%) in both apparent and plastic viscosity and yield value over a seven-day period. The conventionally processed allulose milk chocolate had comparatively high rheological characteristics initially but after one day, the milk chocolate was too thick to obtain measurements.

TABLE 4

| | Time Zero | | | 1 Day | | | 4 Day | | | 5 Day | | | 7 Day | | |
|---|---|---|---|---|---|---|---|---|---|---|---|---|---|---|---|
| | AV | PV | YV | AV | PV | YV | AV | PV | YV | AV | PV | YV | AV | PV | YV |
| Variant | (cp) | (cp) | (dy/cm²) | (cp) | (cp) | (dy/cm²) | (cp) | (cp) | (dy/cm²) | (cp) | (cp) | (dy/cm²) | (cp) | (cp) | (dy/cm²) |
| Allulose MC | 4050 | 1476 | 31.9 | 3525 | 1367 | 24.7 | 3175 | 1228 | 20.4 | 3575 | 1380 | 26.2 | 3925 | 1584 | 27.3 |
| (water, | | | | | | | | | | | | | | | |
| lecithin | | | | | | | | | | | | | | | |
| processed) | | | | | | | | | | | | | | | |
| Allulose MC | 4975 | 1398 | 61 | 7650 | 2383 | 85 | 9050 | 2822 | 97.3 | 8700 | 2660 | 95.2 | 10150 | 3850 | 91.2 |
| (lecithin | | | | | | | | | | | | | | | |
| processed) | | | | | | | | | | | | | | | |

| | | | | |
|---|---|---|---|---|
| Conven- | 12150 | 3638 | 142.8 | Too Thick to Measure |
| tionally | | | | |
| Processed | | | | |
| Allulose MC | | | | |

### Example 2: Overdosing Milk Chocolate with Emulsifiers

Nine kilograms of allulose milk chocolate was prepared with the following base formula as shown in Table 5 below:

TABLE 5
Allulose Milk Chocolate Formula

| | |
|---|---|
| Bulk Fillers | 12.00% |
| Allulose | 25.00% |
| Tagatose | 18.00% |
| Cocoa Butter | 15.00% |
| Dutched Cocoa | 2.00% |
| Unsweetened Chocolate | 18.00% |
| AMF | 2.00% |
| Cream Powder | 7.00% |
| Flavors | 1.00% |
| Total | 100% |
| Percent Fat | 33.00% |

The process was the traditional mix/refine/conche method. The initial batching was at a 26% fat level. The mixture was ground using a Buhler 300 mm laboratory scale roll refiner. The batch was ground to a 25-micron particle size (handheld micrometer). The resulting ground material was split into six equal batches. Each batch was conched in an eight-quart Globe orbital mixer with mixer speed set at 1. The water bath was set for 45° C. The batches were conched for at least 4 hours. At the start of the conche cycles, the balance of the fats was added. Thirty minutes before the end of the conche, the surfactants were added. Each batch had a different amount of lecithin and PGPR added. The sample was then stored at 120° F. (49° C.).

Results:

As shown in Table 6 below, higher percentages of lecithin resulted in chocolates with lower plastic viscosities at time zero regardless of PGPR percentage. It is important to note that lecithin is known to increase yield value and have no effect on plastic viscosity when added beyond its optimum use level, which in a typical chocolate is around 0.3-0.4%. In the examples in Table 6 below, the lecithin continued to diminish the plastic viscosity even at levels as high as 0.70%. The effect of PGPR on yield value was stronger than that of lecithin, shown by the tendency of higher PGPR percentages to lead to lower yield values at time zero. Lecithin percentage also impacted yield values but to a lesser extent.

The plastic viscosity of all variants increased after two weeks of storage at 120° F. (49° C.) and was lowest in the variants with the highest lecithin content. The yield value of variants 5 and 3 decreased over the storage period, but this is considered acceptable since lower yield generally does not negatively impact chocolate processing. Variants 2, 4, and 6 were completely solidified after two weeks, so viscosity data was unable to be collected. The data suggests that higher emulsifier/surfactant levels in allulose chocolate prevent significant thickening.

TABLE 6

| | | | Time Zero | | | Two Week | | |
|---|---|---|---|---|---|---|---|---|
| | Lecithin | PGPR | AV | PV | YV | AV | PV | YV |
| Variant | % | % | (cp) | (cp) | (dy/cm²) | (cp) | (cp) | (dy/cm²) |
| 5 | 0.70 | 0.18 | 13150 | 1615 | 252.0 | 11150 | 2372 | 150.0 |
| 3 | 0.46 | 0.00 | 14250 | 2122 | 243.0 | 17000 | 4603 | 183.0 |
| 1 | 0.45 | 0.55 | 5375 | 2328 | 35.3 | 8950 | 4641 | 39.2 |
| 2 | 0.21 | 0.33 | 7800 | 3749 | 42.0 | — | — | — |
| 6 | 0.10 | 0.70 | 8250 | 7892 | 2.1 | — | — | — |
| 4 | 0.10 | 0.00 | 47250 | 10173 | 586.0 | — | — | — |

—* too thick to measure via Brookfield viscometer

### Example 3: Overdosing Milk Chocolate with Emulsifiers

One hundred pounds of allulose milk chocolate, with the formula described in Example 1, was made with the traditional process described in Example 2. The ingredients were batched to 25% fat in a 140-quart Hobart mixer and were ground by using a Buhler 300 mm three roll refiner as the pre-refiner and a Buhler 600 mm three roll refiner as the finishing refiner. The refiner flake was placed in a 150-pound capacity McCarter Pug Mill conche. The balance of the fat was added at the start of the conching cycle. After four hours, the surfactants, lecithin and PGPR, were added at 0.3% and 0.1% respectively and allowed to mix for 30 minutes. The final milk chocolate was charged into a system composing of a 200-pound capacity vertical tank, a positive displacement pump, and piping 1.5-inch diameter stainless steel pipe that connect the tank to the pump. The pipes also were routed in a 30-foot loop from the pump back to the top of the tank. The system was set up in a room with the temperature held at a constant 117° F. (47° C.). The pump was turned on and the milk chocolate flowed through the pipes and circulated through the system. After a short period of time, the pump was turned off and the system was at rest. After three weeks, a valve was opened at the bottom of a five-foot vertical length of pipe. The viscosity of the allulose milk chocolate in the pipe prevented the milk chocolate from flowing out of the pipe. The pump was turned on and the pipes vigorously vibrated to initiate flow. Once flowing, an additional 0.3% lecithin and 0.1% PGPR were added to the milk chocolate and allowed to mix in the system for 90 minutes. The system was again allowed to rest for three weeks. The same valve was opened and the allulose milk chocolate freely flowed from the pipe demonstrating thickening did not occur. The rheological data from the lower surfactant level chocolate and the higher level are shown in Table 7 below:

TABLE 7

| | Initial | | | After Hold | | |
|---|---|---|---|---|---|---|
| Allulose | AV | | YV | AV | | YV |
| MC | (cp) | PV(cp) | (Dy/cm²) | (cp) | PV(cp) | (Dy/cm²) |
| Lower | 8250 | 2122 | 38.5 | 11060 | 4947 | 59.4 |
| Surfactant | | | | | | |
| AMC | | | | | | |
| Higher | 10150 | 4989 | 59.7 | 2625 | 1892 | 3.7 |
| Surfactant | | | | | | |
| AMC | | | | | | |

### Example 4: Overdosing with lecithin and adding moderate levels of PGPR in Allulose Milk Chocolate Confections

Four 6-kilogram batches of chocolate were produced based on the following Allulose Milk Chocolate Formula (pre-surfactant addition):

Allulose Milk Chocolate Formula

| | |
|---|---|
| Allulose | 46.30 |
| Cocoa Butter | 15.40 |
| Unsweetened Chocolate | 16.10 |
| AMF | 7.06 |
| NFMS | 15.10 |
| Flavors | 0.04 |
| Total | 100.00 |

Each batch was mixed at 23% fat and refined on a Buhler 300 mm roll refiner to a particle size of roughly 20 microns as measured by a handheld micrometer. Once refined, each batch was split into four 1.5 kg bowls and conched for 3.5 hours at 23.7%-24.8% fat in 8qt Globe mixers set to speed 1 with 50° C. water baths. Each bowl received 12.5 g cocoa butter at the start of the conche. The emulsifier/surfactant was added according to Table 8 below with the lecithin content ranging from 0.3%-1% and PGPR from 0.3%-0.5%.

The order of addition of the “1st fat” indicates that all of the surfactant was added at the start of the conche. “Both” indicates that half of the surfactant (50% of the lecithin and 50% of the PGPR) was added at the start of the conche and the other half was added during the standardizing step at 3.5 hours. “End of conche” indicates that all of the surfactant was added at 3.5 hours. All chocolates were taken off the conche at roughly 4 hours. Viscosity was measured initially and after 3 weeks of storage at 50° C. The results are shown in Table 8 below.

TABLE 8

| | Initial | | | After Hold (3 weeks) | | | Level & Time | | |
|---|---|---|---|---|---|---|---|---|---|
| | AV | PV | YV | AV | PV | YV | Lecithin | PGPR | Addition |
| Variant | (cP) | (cP) | (Dy/cm²) | (cP) | (cP) | (Dy/cm²) | % | % | Time |
| 1 | 9950 | 4557 | 55.2 | 15630 | 9807 | 34.3 | 0.80 | 0.50 | Both |
| 2 | 19050 | 3297 | 293.0 | 15500 | 4248 | 161.0 | 0.76 | 0.10 | Both |
| 3 | 13880 | 6620 | 66.8 | 17690 | 9712 | 55.8 | 0.30 | 0.10 | 1^{st} Fat |
| 4 | 17630 | 3502 | 239.0 | 18940 | 5750 | 175.0 | 1.00 | 0.30 | 1^{st} Fat |
| 5 | 22250 | 2971 | 403.0 | 17560 | 2938 | 282.0 | 1.00 | 0.10 | End |
| 6 | 9063 | 11210 | 3.0 | 18440 | 20449 | 1.4 | 0.30 | 0.50 | End |
| 7 | 18440 | 6712 | 140.0 | 21190 | 12558 | 57.3 | 0.80 | 0.50 | 1^{st} Fat |
| 8 | 14400 | 8486 | 49.5 | 11810 | 6246 | 49.7 | 0.46 | 0.30 | 1^{st} Fat |
| 9 | 9938 | 3962 | 66.3 | 12130 | 5979 | 52.7 | 0.30 | 0.10 | Both |
| 10 | 13000 | 14098 | 0.5 | 18250 | 18431 | 0.0 | 0.30 | 0.50 | 1^{st} Fat |
| 11 | 21690 | 3906 | 310.0 | 15000 | 3851 | 163.0 | 1.00 | 0.10 | 1^{st} Fat |
| 12 | 6550 | 2615 | 45.1 | 8000 | 3129 | 54.9 | 0.60 | 0.27 | End |
| 13 | 7300 | 7456 | 0.0 | 12560 | 12957 | 0.1 | 0.30 | 0.50 | Both |
| 14 | 7400 | 3600 | 34.3 | 6600 | 3173 | 30.9 | 0.30 | 0.10 | End |
| 15 | 4750 | 2566 | 18.2 | 8188 | 4915 | 21.2 | 0.80 | 0.50 | End |
| 16 | 17750 | 5678 | 154.0 | 19250 | 6873 | 144.0 | 1.00 | 0.30 | Both |

The results show that the allulose milk chocolate confections with elevated levels of lecithin (>0.45%) and moderate levels of PGPR (0.1% to 0.3%) had stable viscosity levels when the emulsifiers/surfactants are added during the beginning and the end of the conche. The confections with lower levels of lecithin, high levels of PGPR and/or had the emulsifiers/surfactants added at the start of the conche had unstable rheological properties. The exception of adding emulsifiers/surfactants at the start of the conche step resulting in unstable properties is when the confection has very high levels of lecithin (1.0%).

### Example 5: Zero Sugar Allulose Milk Chocolate Made with Ammonium Phosphatide (AMP) and PGPR

Twelve hundred grams of chocolate were made using the following PREMIX formula.

| Premix | % |
|---|---|
| Bulking Agents (Fibers & others) | 26.70 |
| Allulose | 25.00 |
| Milk Ingredients | 8.30 |
| Unsweetened Chocolate | 20.00 |
| Cocoa Butter | 10.00 |
| Flavors | 0.15 |
| Conch/standardize | |
| Cocoa Butter | 7.00 |
| Milk Fat | 2.15 |
| AMP | 0.40 |
| PGPR | 0.30 |
| Total | 100.00 |

The Premix was batched and refined on a Buhler 300 mm roll refiner to a particle size of roughly 20 microns as measured by a handheld micrometer. The refined material was conched at 50° C. for 3.5 hours. AMP and the remaining cocoa butter were added at the beginning of conch. At the end of 3.5 hours conch, PGPR, AMF, and flavors were added, and mixing was continued for another 30 min to complete chocolate making. The obtained chocolate had 1.16% moisture content, 35.5% fat, apparent viscosity 3900 cp, plastic viscosity 1865 cp, and yield value of 21.1 dynes/cm². The chocolate was stable without gelling after 4 wks of stage at 50° C.

### Example 6: Increasing Fat Content in an Allulose Confection

Six 2-kilogram batches of chocolate were made based on the following refining Allulose Model Chocolate Formula:

Allulose Model Chocolate Formula

| | |
|---|---|
| Allulose | 57.00 |
| Cocoa Butter | 23.00 |
| NFMS | 20.00 |
| Total | 100.00 |

Ingredients were blended at 24.5% fat in 20-quart Globe mixers until a dough-like consistency was achieved and then were held in a 50° C. heated cabinet until refined. Mixtures were refined on a Buhler 300 mm roll refiner at 40° C. to a particle size of roughly 20-25 microns as measured by handheld micrometer Refined flake was placed directly back on the mixer. Mixtures were then conched at 24.5% fat in 8-quart Globe mixers set to speed 1 with 50° C. water baths. Batches were standardized at three and a half hours to the final fat levels and taken off the conche at roughly four hours.

Each batch was standardized with 0.3% lecithin and 0.1% PGPR. The Table below indicates the additional cocoa butter and milk fat added during standardizing, as percentage of total mass.

| Final Fat (%) | AMF (%) | Cocoa Butter (%) |
|---|---|---|
| 29 | 5.5 | 0 |
| 31 | 6.0 | 2.2 |
| 33 | 6.3 | 4.6 |
| 35 | 6.7 | 6.8 |
| 37 | 7.1 | 9.1 |
| 39 | 7.5 | 11.3 |

Viscosity was measured initially and after 4 weeks of storage at 50° C. The results are shown in Table 9 below.

TABLE 9

| | Initial | | | After Hold (4 weeks) | | |
|---|---|---|---|---|---|---|
| | AV | PV | YV | AV | PV | YV |
| Fat % | (cP) | (cP) | (Dy/cm²) | (cP) | (cP) | (Dy/cm²) |
| 29 | 8563 | 4088 | 42.6 | 25130 | 19003 | 25.8 |
| 31 | 6750 | 3414 | 30.2 | 17750 | 13260 | 19.0 |
| 33 | 6650 | 3375 | 28.7 | 14190 | 9844 | 21.1 |
| 35 | 3325 | 1572 | 16.6 | 11250 | 7363 | 22.6 |
| 37 | 3800 | 2039 | 14.4 | 8100 | 3749 | 43.1 |
| 39 | 3675 | 2149 | 11.1 | 5500 | 3356 | 14.8 |

Further, the disclosure comprises additional notes and examples as detailed below.

Clause 1. A milk chocolate confectionery product having a reduced sugar content comprising:
a fat,
a sweetener comprising at least one rare sugar, a combination of rare sugars, or a combination of at least one rare sugar and at least one standard carbohydrate sugar, wherein the at least one rare sugar is selected from the group consisting of allulose, tagatose, allose, sorbose, apiose, ribose, L-rhamnose, L-fructose, D-mannose, trehalose, and kojibiose,
a milk ingredient,
a cacao ingredient,
an emulsifier/surfactant, and
an optional bulk filler and/or flavor,
wherein the milk chocolate confectionery product has a stable plastic viscosity at 40° C. using the NCA/CMA Casson regression model of 500 to 10,000 cp, and stable yield value at 40° C. using the NCA/CMA Casson regression model of 1-150 dynes/cm².

Clause 2. The milk chocolate confectionery product according to clause 1, wherein the milk chocolate confection has a stable plastic viscosity at 40° C. using the NCA/CMA Casson regression model of 600 to 10,000 cp and a stable yield value at 40° C. using the NCA/CMA Casson regression model of 1-150 dynes/cm².

Clause 3. The milk chocolate confection according to clause 1, wherein the milk chocolate confection has a stable plastic viscosity at 40° C. using the NCA/CMA Casson regression model of 1,000 to 10,000 cp and a stable yield value at 40° C. using the NCA/CMA Casson regression model of 1 to 150 dynes/cm².

Clause 4. The milk chocolate confectionery product according to clause 1, further having an apparent viscosity at 40° C. and 20 rpm (as measured by Brookfield viscometer) of 1, 000 to 15,000 cp.

Clause 5. The milk chocolate confectionery product according to clause 1 or 2, further having an apparent viscosity at 40° C. and 20 rpm (as measured by Brookfield viscometer) of 3,000 to 12,000 cp.

Clause 6. The milk chocolate confectionery product according to clause 3, further having an apparent viscosity at 40° C. and 20 rpm (as measured by Brookfield viscometer) of 4,000 to 10,000 cp.

Clause 7. The milk chocolate confectionery product according to any one of clauses 1 to 5, wherein the at least one rare sugar comprises allulose.

Clause 8. The milk chocolate confectionery product according to clause 7, wherein allulose has a particle size distribution of particles 6.0 μm of about 15% or less.

Clause 9. The milk chocolate confectionery product according to clause 8, wherein the allulose has a particle size distribution of particles≤6.0 μm of about 13% or less.

Clause 10. The milk chocolate confectionery product according to clause 8, wherein the allulose has a particle size distribution of particles≤6.0 μm of about 11% or less.

Clause 11. The milk chocolate confectionery product according to any one of clauses 1 to 10, wherein particles having a particle size of about 2 50 μm are rounded crystals.

Clause 12. The milk chocolate confectionery product according to anyone of clauses 1 to 11, wherein the allulose has a surface area less than 70% of roll refined allulose for a 25 micron milk chocolate (as estimated by particle size distribution analysis).

Clause 13. The milk chocolate confectionery product according to anyone of clauses 1 to 12, wherein the allulose has a surface area less than 50% of roll refined allulose for a 25 micron milk chocolate (as estimated by particle size distribution analysis).

Clause 14. The milk chocolate confectionery product according to any one of clauses 1 to 13, having a fat content of about 2 30% by weight.

Clause 15. The milk chocolate confectionery product according to clause 14, having a fat content of about ≥36% by weight.

Clause 16. The milk chocolate confectionery product according to clause 15 having a fat content of about ≥38% by weight.

Clause 17. The milk chocolate confectionery product according to clause 16, having a fat content of about ≥40% by weight.

Clause 18. The milk chocolate confectionery product according to any one of clauses 1 to 17, having a total moisture content of less than about 1.5% by weight.

Clause 19. The milk chocolate confectionery product according to any one of clauses 1 to 18, having a total moisture content of less than about 1.2% by weight.

Clause 20. The milk chocolate confectionery product according to clause 18, having a total moisture content of about ≤1.0% by weight.

Clause 21. The milk chocolate confectionery product according to clause 18, having a total moisture content of about 0.8% by weight.

Clause 22. The milk chocolate confectionery product according to clause 18, having a total moisture content of about 0.6% by weight.

Clause 23. The milk chocolate confectionery product according to any one of clauses 1 to 22, wherein the emulsifier/surfactant comprises lecithin having a content of about 0.3%-0.7% by weight.

Clause 24. The milk chocolate confectionery product according to clause 23, having a total lecithin content of about 0.4%-0.6% by weight.

Clause 25. The milk chocolate confectionery product according to any one of clauses 1 to 22, wherein the emulsifier/surfactant comprises PGPR having a content of about 0.1%- about 0.3% by weight.

Clause 26. The milk chocolate confectionery product according to any one of clauses 1 to 22, wherein the emulsifier/surfactant comprises a combination of lecithin and PGPR and has a content of lecithin of about 0.6% by weight, and a content of PGPR of about 0.2% by weight.

Clause 27. The milk chocolate confectionery product according to any one of claims 1 to 22, wherein the emulsifier/surfactant comprises AMP having a content of about 0.1% to about 0.7% by weight.

Clause 28. The milk chocolate confectionery product according to any one of claims 1-22, wherein the emulsifier/surfactant comprises a combination of AMP and PGPR and AMP has a content of about 0.4% by weight and PGPR has a content of about 0.3% by weight.

Clause 29. The milk chocolate confectionery product according to any one of claims 1 to 28, wherein the plastic viscosity is stable at temperatures of from about 100° F. (37.78° C.) to about 120° F. (48.89° C.) for at least one month.

Clause 29. A method for making a milk chocolate confectionery product having a reduced sugar content, the method comprising:
mixing fat and a sweetener comprising at least one rare sugar or a combination of at least one rare sugar and at least one standard carbohydrate sugar, wherein the at least one rare sugar is selected from the group consisting of allulose, tagatose, allose, sorbose, apiose, ribose, L-rhamnose, L-fructose, and D-mannose to obtain a fat/sweetener mixture;
refining the fat/sweetener mixture to obtain a particle size of <45 μm;
adding water and a surfactant to the fat/sweetener mixture and drying;
separately mixing unsweetened chocolate, milk ingredients for milk chocolate confections, and chocolate making ingredients to obtain chocolate mixture and refining the chocolate mixture to obtain a particle size of <45 μm; and
combining the refined fat/sweetener mixture and the refined chocolate mixture,
wherein the milk chocolate confectionery product has a plastic viscosity at 40° C. using the NCA/CMA Casson regression model of 500 to 10,000 cp, and a yield value at 40° C. using the NCA/CMA Casson regression model of 1-150 dynes/cm².

Clause 26. The method according to clause 25, wherein the milk chocolate confectionery product further has an apparent viscosity at 40° C. and 20 rpm (as measured by Brookfield viscometer) of 1,000 to 15,000 cp.

Clause 27. The method according to clause 25 or 26, wherein confectionery product the milk chocolate has an apparent viscosity at 40° C. and 20 rpm (as measured by Brookfield viscometer) of 3,000 to 12,000 cp.

Clause 28. The method according to clause 27, wherein the milk chocolate confectionery product has an apparent viscosity at 40° C. and 20 rpm (as measured by Brookfield viscometer) of 4,000 to 10,000 cp.

Clause 29. The method according to clause 27, wherein the milk chocolate confectionery product has an apparent viscosity at 40° C. and 20 rpm (as measured by Brookfield viscometer) of 14,000 to 15,000 cp.

Clause 30. The method according to any one of clauses 25-29, wherein the at least one rare sugar comprises allulose.

Clause 31. The method according to clause 30, wherein the allulose has a particle size distribution of particles≤6.0 μm of about 15% or less.

Clause 32. The method according to clause 30, wherein the allulose has a particle size distribution of particles 6.0 μm of about 13% or less.

Clause 33. The method according to clause 30, wherein the allulose has a particle size distribution of particles 6.0 μm of about 11% or less.

Clause 34. The method according to any one of clauses 25 to 33, wherein particles of allulose having a particle size of about ≥50 μm are rounded crystals.

Clause 35. The method according to any one of clauses 25 to 34, wherein the allulose has a surface area less than 70% of roll refined allulose as estimated by particle size distribution analysis.

Clause 36. The method according to any one of clauses 25 to 35, wherein the milk chocolate confectionery product has a fat content of about ≥30% by weight.

Clause 37. The method according to clause 36, having a fat content of about ≥36% by weight.

Clause 38. The method according to clause 36, having a fat content of about 2 38% by weight.

Clause 39. The method according to clause 36, having a fat content of about ≥40% by weight.

Clause 40. The method according to any one of clauses 25 to 39, wherein the milk chocolate confectionery product has a total moisture content of less than about 1.5% by weight.

Clause 40. The method according to any one of clauses 25 to 39, wherein the milk chocolate confectionery product has a total moisture content of less than about 1.2% by weight.

Clause 41. The method according to clause 40, wherein the milk chocolate confectionery product has a total moisture content of about 1.0% by weight.

Clause 42. The method according to clause 40, wherein the milk chocolate confectionery product has a total moisture content of about ≤0.8% by weight.

Clause 43. The method according to clause 40, wherein the milk chocolate confectionery product has a total moisture content of about ≤0.6% by weight.

Clause 44. The method according to any one of clauses 25 to 43, wherein the milk chocolate confectionery product has a total lecithin content of >0.5% by weight.

Clause 45. The method according to clause 44, wherein the milk chocolate confectionery product has a total lecithin content of >0.7% by weight.

Clause 46. The method according to clause 44, wherein the milk chocolate confectionery product has a total lecithin content of >0.9% by weight.

Clause 47. The method according to any one of clauses 25 to 46, wherein the milk chocolate confectionery product has a total PGPR content of >0.3% by weight.

Clause 48. The method according to any one of clauses 25 to 47, wherein the plastic viscosity is stable at temperatures of from about 100° F. (37.78° C.) to about 120° F. (48.89° C.) for at least one month.

Clause 49. A method of preventing or inhibiting thickening of milk chocolate which comprises at least one rare sugar, said method comprising: reducing total surface area of particles of the at least one rare sugar, adding fat in an amount of about 30% by weight or more, and/or adjusting total moisture of the milk chocolate to below 1.5%, and wherein the milk chocolate has a plastic viscosity at 40° C. using the NCA/CMA Casson regression model of 500 to 10,000 cp, and a yield value at 40° C. using the NCA/CMA Casson regression model of 1-150 dynes/cm².

Clause 50. The method according to clause 49, wherein the milk chocolate further has an apparent viscosity at 40° C. and 20 rpm (as measured by Brookfield viscometer) of 1, 000 to 15,000 cp.

Clause 51. The method according to clause 49 or 50, wherein the milk chocolate further has an apparent viscosity at 40° C. and 20 rpm (as measured by Brookfield viscometer) of 3,000 to 12,000 cp.

Clause 52. The method according to any one of clause 51, wherein the milk chocolate further has an apparent viscosity at 40° C. and 20 rpm (as measured by Brookfield viscometer) of 4,000 to 10,000 cp.

Clause 53. The method according to clause 51, wherein the milk chocolate further has an apparent viscosity at 40° C. and 20 rpm (as measured by Brookfield viscometer) of 14,000 to 15,000 cp.

Clause 54. The method according to any one of clauses 49-53, wherein the at least one rare sugar is in combination with other rare sugars or in combination with at least one standard carbohydrate sugar.

Clause 55. The method according to any of clauses 49 to 54, wherein the at least one rare sugar is selected from the group consisting of allulose, tagatose, allose, sorbose, apiose, ribose, L-rhamnose, L-fructose, D-mannose, trehalose, and kojibiose.

Clause 56. The method according to any one of clauses 49 to 55, wherein the at least one rare sugar comprises allulose.

Clause 57. The method according to clause 56, wherein the allulose has a particle size distribution of particles 6.0 μm of about 15% or less.

Clause 58. The method according to clause 56, wherein the allulose has a particle size distribution of particles 6.0 μm of about 13% or less.

Clause 59. The method according to clause 56, wherein the allulose has a particle size distribution of particles≤6.0 μm of about 11% or less.

Clause 60. The method according to any one of clauses 49-59, wherein particles of allulose have a particle size of about ≥50 μm are rounded crystals.

Clause 61. The method according to any one of clauses 49-60, wherein the allulose has a surface area less than 70% of roll refined allulose as estimated by particle size distribution analysis.

Clause 62. The method according to any one of clauses 49-61, wherein the milk chocolate has a fat content of about ≥30% by weight.

Clause 63. The method according to clause 62, wherein the milk chocolate has a fat content of about 2 36% by weight.

Clause 64. The method according to clause 62, wherein the milk chocolate has a fat content of about ≥38% by weight.

Clause 65. The method according to clause 62, wherein the milk chocolate has a fat content of about 2 40% by weight.

Clause 66. The method according to any one of clauses 49-65, wherein the milk chocolate has a total moisture content of less than about 1.5% by weight.

Clause 66. The method according to any one of clauses 49-65, wherein the milk chocolate has a total moisture content of less than about 1.2% by weight.

Clause 67. The method according to any one of clauses 49-66, wherein the milk chocolate has a total moisture content of about ≤1.0% by weight.

Clause 68. The method according to clause 67, wherein the milk chocolate has a total moisture content of about ≤0.8% by weight.

Clause 69. The method according to clause 67, wherein the milk chocolate has a total moisture content of about ≤0.6% by weight.

Clause 70. The method according to any one of clauses 49-69, wherein the milk chocolate has a total lecithin content of >0.5% by weight.

Clause 71. The method according to clause 70, wherein the milk chocolate has a total lecithin content of >0.7% by weight.

Clause 72. The method according to clause 70, wherein the milk chocolate confectionery has a total lecithin content of >0.9% by weight.

Clause 73. The method according to any one of clauses 49 to 72, wherein the milk chocolate has a total PGPR content of >0.3% by weight.

Clause 74. The method according to any one of clauses 49-73, wherein the plastic viscosity is stable at temperatures of from about 100° F. (37.78° C.) to about 120° F. (48.89° C.) for at least one month.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an example can or may comprise certain elements or features does not exclude other examples of the present technology that do not contain those elements or features.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

While the foregoing specification illustrates and describes exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular example(s) disclosed as the best mode contemplated for carrying out this invention, but that the invention will include all examples falling within the scope of the appended claims.

1. (canceled)

2. (canceled)

3. (canceled)

4. (canceled)

5. (canceled)

6. (canceled)

7. (canceled)

8. (canceled)

9. A method for making a milk chocolate confectionery product having a reduced sugar content, the method comprising:
mixing fat and a sweetener comprising at least one rare sugar or a combination of at least one rare sugar and at least one standard carbohydrate sugar, wherein the at least one rare sugar is selected from the group consisting of allulose, tagatose, allose, sorbose, apiose, ribose, L-rhamnose, L-fructose, and D-mannose to obtain a fat/sweetener mixture;
refining the fat/sweetener mixture to obtain a particle size of <45 μm;
adding water and an emulsifier/surfactant to the fat/sweetener mixture and drying;
separately mixing unsweetened chocolate, at least one milk ingredient for milk chocolate confections, and chocolate making ingredients to obtain a chocolate mixture and refining the chocolate mixture to obtain a particle size of <45 μm; and
combining the refined fat/sweetener mixture and the refined chocolate mixture,
wherein the milk chocolate confectionery product has a stable plastic viscosity at 40° C. using the NCA/CMA Casson regression model of 500 to 10,000 cp, and stable yield value at 40° C. using the NCA/CMA Casson regression model of 1-150 dynes/cm², and
wherein the plastic viscosity is stable at temperatures of from about 100° F. (38° C.) to about 120° F. (49° C.) for at least one month.

10. The method according to claim 9, wherein the milk chocolate confectionery product further has an apparent viscosity at 40° C. and 20 rpm (as measured by Brookfield viscometer) of 1, 000 to 15,000 cp.

11. The method according to claim 9, wherein the at least one rare sugar comprises allulose, and wherein the emulsifier/surfactant is selected from the group consisting of lecithin, PGPR, AMP, and combinations or mixtures thereof.

12. The method according to claim 11, wherein the allulose has a surface area less than 70% of roll refined allulose for a 25 micron milk chocolate (as estimated by particle size distribution analysis).

13. The method according to claim 11, having a fat content of about 30% by weight.

14. The method according to claim 11, having a total moisture content of less than about 1.5% by weight.

15. The method according to claim 11, wherein the emulsifier/surfactant comprises lecithin having a content of about 0.2% to about 0.9% by weight, or PGPR having a content of about 0.1% to about 0.3% by weight, or a combination of lecithin and PGPR said combination having a content of lecithin of about 0.6% by weight, and a content of PGPR of about 0.2% by weight.

16. The method according to claim 11, wherein the emulsifier/surfactant comprises AMP having a content of about 0.1% to about 0.7% by weight, or a combination of AMP and PGPR said combination having a content of AMP of about 0.4% by weight and a content of PGPR of about 0.3% by weight.

17. A method of preventing or inhibiting thickening of milk chocolate which comprises a sweetener comprising at least one rare sugar or a combination of at least one rare sugar and at least one standard carbohydrate sugar, said method comprising:
reducing total surface area of particles of the at least one rare sugar, adding fat in an amount of about 30% by weight or more, overdosing the milk chocolate with an emulsifier/surfactant, and/or adjusting total moisture of the milk chocolate to below 1.5%, wherein the at least one rare sugar is selected from the group consisting of allulose, tagatose, allose, sorbose, apiose, ribose, L-rhamnose, L-fructose, D-mannose, trehalose, and kojibiose and
wherein the milk chocolate has a stable plastic viscosity at 40° C. using the NCA/CMA Casson regression model of 500 to 10,000 cp, and stable yield value at 40° C. using the NCA/CMA Casson regression model of 1-150 dynes/cm², and
wherein the plastic viscosity is stable at temperatures of from about 100° F. (38° C.) to about 120° F. (49° C.) for at least one month.

18. The method according to claim 17, wherein the milk chocolate further has an apparent viscosity at 40° C. and 20 rpm (as measured by Brookfield viscometer) of 1,000 to 15,0000 cp.

19. The method according to claim 17, wherein the rare sugar comprises allulose.

20. The method according to claim 19, wherein the allulose has a surface area less than 70% of roll refined allulose for a 25 micron milk chocolate (as estimated by particle size distribution analysis).

21. The method according to claim 19, wherein the emulsifier/surfactant is selected from the group consisting of lecithin, PGPR, AMP, and combinations or mixtures thereof.

22. The method according to claim 21, wherein the emulsifier/surfactant comprises lecithin having a content of about 0.2% to about 0.9% by weight, or PGPR having a content of about 0.1% to about 0.3% by weight, or a combination of lecithin and PGPR, said combination having a content of lecithin of about 0.6% by weight and a content of PGPR of about 0.2% by weight.

23. The method according to claim 21, wherein the emulsifier/surfactant comprises AMP having a content of about 0.1% to about 0.7% by weight or a combination of AMP and PGPR, said combination having a content of AMP of about 0.4% by weight and a content of PGPR of about 0.3% by weight.
